(19) United States
(12) Patent Application Publication
(10) Pub. No.: US 2017/0243268 A1
(43) Pub. Date: Aug. 24, 2017

(54) METHOD AND SYSTEM FOR DETERMINING AN OPTIMIZED SERVICE PACKAGE MODEL FOR MARKET PARTICIPATION

(71) Applicant: INTERNATIONAL BUSINESS MACHINES CORPORATION, Armonk, NY (US)

(72) Inventors: Mari A. Fukuda, Tokyo (JP); Kugamoorthy Gajananan, Tokyo (JP); Shun Jiang, San Jose, CA (US); Aly Megahed, San Jose, CA (US); Taiga Nakamura, San Jose, CA (US); Mark A. Smith, Warwick (GB)

(21) Appl. No.: 15/050,986

(22) Filed: Feb. 23, 2016

(51) Int. Cl. G06Q 30/06

(52) U.S. Cl. CPC G06Q 30/0611

(57) ABSTRACT

A computer-implemented method for adjusting service items in service packages, the method includes formulating a service package having a plurality of service items, the plurality of service items including a computer-related service provided over a network, determining an anomaly index value for each service item to identify a service item in the service package to be excluded, wherein the anomaly index value for the service item to be excluded exceeds an anomaly threshold value, identifying a substitute service item from a plurality of substitute services to replace the service item to be excluded, substituting the service item with the substitute service item to generate an optimized service package having a maintained threshold quality level, wherein the optimized service package includes a portion of the plurality of service items and one or more substitute service items, and replacing the service package with the optimized service package on the network.

### BACKGROUND

Technical Field

The present invention generally relates to determining an optimized service package model, and more particularly to determining an optimized service pricing model for market participation.

Description of the Related Art

Service providers typically compete for service contracts by submitting bids and/or proposals for providing one or more services. The services indicated in such proposals are often complex, making it difficult and time consuming to provide cost estimates for such proposals. Bids for services are typically accepted when the pricing for such services is competitive with the market, among other factors.

Top-down approaches include determining price points of complex bids and probability of winning such bids. Bottom-up approaches for estimating pricing typically include providing costs for each individual service, computing the total cost for all services, and adding a profit margin to determine the total cost of the entire proposal, which may then be compared to historical and/or market data to determine the competitiveness of the proposal. However, determining a detailed list of services to be included in such proposals and estimating the costs of such services are time consuming and further delay the pricing decision. For example, trial and error approaches rely on domain knowledge and experience of a solution designer who selects the services to be included in the bids. However, solution designers may not know all the detailed requirements at all service levels during the bidding process. Current approaches, therefore, do not provide efficient methods to adjust such proposals and/or alter the selected services to be provided to generate proposals competitive with the market.

### SUMMARY

In accordance with the present principles, a method for adjusting service items in service packages is provided. The method includes formulating a service package having a plurality of service items, at least one of the plurality of service items including a computer-related service provided over a network, determining an anomaly index value for each service item to identify at least one service item in the service package to be excluded, wherein the anomaly index value for the at least one service item to be excluded exceeds an anomaly threshold value, identifying at least one substitute service item from a plurality of substitute services to replace the at least one service item to be excluded, substituting the at least one service item with the at least one substitute service item to generate an optimized service package having a maintained threshold quality level, wherein the optimized service package includes a portion of the plurality of service items and one or more substitute service items, and replacing the service package with the optimized service package on the network.

According to another aspect of the present principles, a system for adjusting service items in service packages is provided. The system includes a service generator to formulate a service package having a plurality of service items, at least one of the plurality of service items including a computer-related service provided over a network, an anomaly indexer to determine an anomaly index value for each service item to identify at least one service item in the service package to be excluded, wherein the anomaly index value for the at least one service item to be excluded exceeds an anomaly threshold value, a service reassignment unit, coupled to the processor, to identify at least one substitute service item from a plurality of substitute services to replace the at least one service item to be excluded, and substitute the at least one service item with the at least one substitute service item to generate an optimized service package having a maintained threshold quality level, wherein the optimized service package includes a portion of the plurality of service items and one or more substitute service items, and an updater to replace the service package with the optimized service package on the network.

According to another aspect of the present principles, a non-transitory computer readable storage medium for adjusting service items in service packages is provided. The non-transitory computer readable storage medium includes a computer readable program for adjusting service items in service packages, wherein the computer readable program, when executed on a computer, causes the computer to perform the steps of formulating a service package having a plurality of service items, at least one of the plurality of service items including a computer-related service provided over a network, determining an anomaly index value for each service item to identify at least one service item in the service package to be excluded, wherein the anomaly index value for the at least one service item to be excluded exceeds an anomaly threshold value, identifying at least one substitute service item from a plurality of substitute services to replace the at least one service item to be excluded, substituting the at least one service item with the at least one substitute service item to generate an optimized service package having a maintained threshold quality level, wherein the optimized service package includes a portion of the plurality of service items and one or more substitute service items, and replacing the service package with the optimized service package on the network.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 shows an exemplary processing method/system for adjusting service items in service packages, in accordance with an embodiment;

FIG. 2 shows an exemplary processing method/system for adjusting service items in service packages, in accordance with an embodiment;

FIG. 3 shows an exemplary processing method/system for adjusting service items in service packages, in accordance with an embodiment;

FIG. 4 is a block/flow diagram illustrating an exemplary method/system for determining an anomaly index threshold value, in accordance with an embodiment;

FIG. 5 shows an exemplary unit cost/baseline graph, in accordance with an embodiment;

FIG. 6 is a block/flow diagram illustrating an exemplary method/system for adjusting service items in service packages, in accordance with an embodiment of the present principles;

FIG. 7 shows an exemplary illustration of baseline similarities of services, in accordance with an embodiment;

FIG. 8 shows an exemplary table illustrating exchangeable services, in accordance with an embodiment;

FIG. 9 shows an exemplary cloud computing node, in accordance with an embodiment of the present principles;

FIG. 10 shows an exemplary cloud computing environment, in accordance with an embodiment of the present principles; and

FIG. 11 shows exemplary abstraction model layers, in accordance with an embodiment of the present principles.

### DETAILED DESCRIPTION

In accordance with the present principles, systems and methods are provided for determining an optimized service package model for market participation. In some embodiments, a method is provided to determine a target value for a service package (e.g., proposed deal) having for one or more service items, wherein the target value is a high-level (e.g., deal-level) value and/or total value for the service package. The target value may be based on objectives of the proposed deal and may include a value lower than a historical value and/or substantially close to a market benchmark value (e.g., value determined by market).

According to one embodiment, exchangeable pairs of services may be automatically selected for the one or more services of the proposed deal and may be compared to historical data to generate an optimized service package model. The optimized service package may include a list of service items to be provided, the services including a portion of the original services of the proposed deal and a portion of substitute services. Accordingly, reliance on the domain knowledge of the solution designer and/or delay in solution designer's operations is reduced since a smaller set of pairs for the one or more services is generated and/or selected, thereby providing an efficient method for determining services and/or costs associated with a bid during the pricing decision.

In further embodiments, the substitute services may be employed to replace excludable services thereby generating an optimized service package without minimizing the quality of the selected services. For example, the number of selected services may be maintained such that the threshold quality level of the optimized service package is maintained (e.g., does not substantially fluctuate), according to one embodiment. In another embodiment, closer baselines may be employed to select the services. A baseline may be defined as a number employed to measure a size of a service, such as a number of servers for server maintenance service, a number of seats for customer support services, a number of Giga Bytes for database services, etc. In some embodiments, the baseline is related to a metric to measure the size of a service depending on the type of service, such as “servers”, “GBs”, “seats”, etc. In another embodiment, an anomaly index value and/or anomaly threshold value may be employed to determine, for each service, whether a similar service (e.g., substitute service) may be included such that the target value is not exceeded.

It should be understood that the term “service” should be interpreted broadly and may include, but is not limited to, computer-related service items relating to labor, management (e.g., database management), and any other service fields provided by, for example, information technology (IT) service providers, which may be provided over a network. In some embodiments, a service item may include a plurality of services arranged in a hierarchical manner. Each of the service items may include a service-level unit cost, which may be a cost associated with performing the service. The present principles may provide at least one of the following advantages, namely, determining a detailed list of service items to be provided, adjusting the selected services to generate service packages competitive with the market, and reducing reliance on domain knowledge of the solution designer.

It should be further understood that each service package may include cost(s) of services to be provided (e.g., a total value for all services). The term “costs” should be interpreted broadly and may include costs associated with time (e.g., man-hours), labor hours, energy, power consumption, etc. In some embodiments, a total cost of a service package may have a structure within the costs of services. For example, the total cost of a service package may include several costs of services, namely service-level unit costs, for each service. In addition, each cost of service can include several costs of subservices. A top-level cost (e.g., total cost) is a summation of all costs of services, subservices, and successive lower level services. The top-level cost may be referred to as a “deal-level cost” and costs at the next lower level (e.g., costs of services) may be referred to as a “service-level cost”. In addition, if costs are considered relatively, they may be referred to as a “high-level cost” or a “low-level cost” according to levels that the costs belong to.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

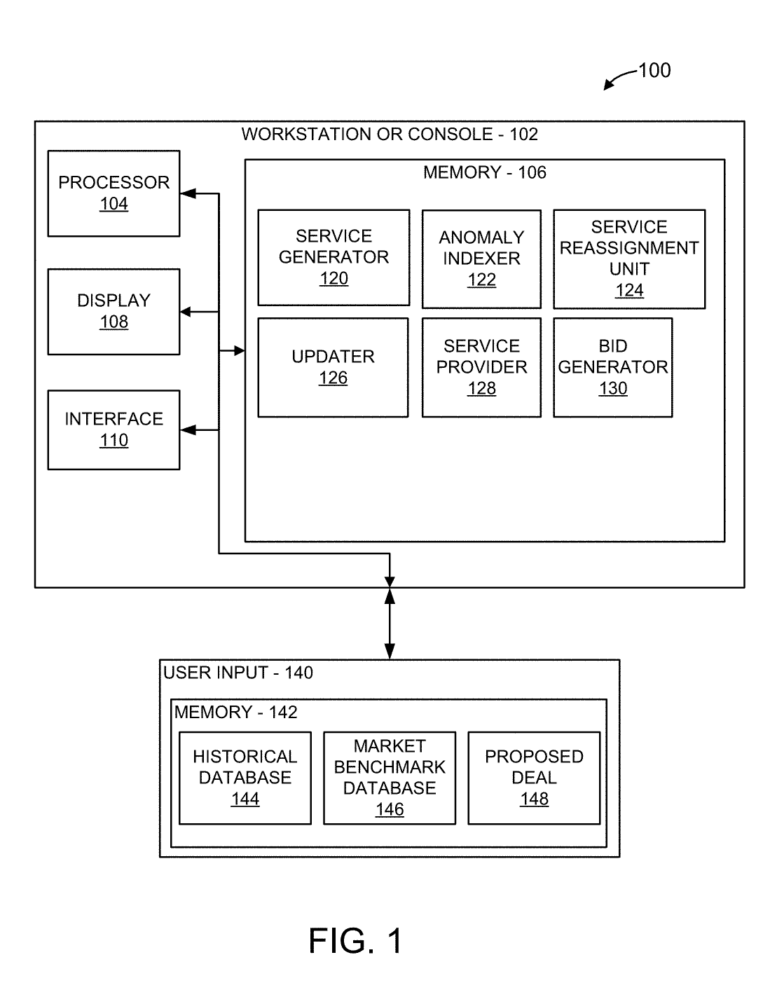

Referring to the drawings in which like numerals represent the same or similar elements and initially to FIG. 1, a system 100 for dynamic pricing management for generating an optimized pricing model for market participation is illustratively depicted in accordance with one embodiment. System 100 may include a workstation or console 102 from which a procedure is supervised and/or managed. Workstation 102 preferably includes one or more processors 104 and memory 106 for storing programs and applications. Memory 106 may store a service generator 120, an anomaly indexer 122, a service reassignment unit 124, an updater 126, a service provider 128, and a bid generator 130.

In one embodiment, workstation 102 is configured to receive data from a user device 140 and/or any element of the user device 140. For example, the workstation 102 may be configured to receive data from a historical database 144, which may include historical service packages (e.g., baselines, services provided and/or service-level unit costs for each service provided, etc.) and/or objectives of the historical service packages, which may be stored in memory 142 in the user device 140. It should be understood that service-level unit costs (SUCs) and service costs may be used interchangeably. In a further embodiment, the workstation 102 may be configured to receive data from a market benchmark database 146, which may include indices to help service providers understand how markets are performing. For example, market benchmarks for outsourcing services may include a unit cost for each service, such as a unit cost of server maintenance.

In an embodiment, the workstation 102 may be configured to receive data from a proposed deal 148, which may include baselines for each service and/or objectives of the proposed deal (e.g., proposed service package). For example, when a client requests a proposal for a service package from service providers, the client may provide the service providers with objectives of the requested proposal (e.g., types of services to be provided, total allotted budget for proposals, etc.). The user device 140 may include, but is not limited to, a computer and/or similarly functioning devices and may be able to communicate with the workstation 102 wirelessly or in a hardwired manner. In an alternate embodiment, the workstation or console 102 and/or memory 106 may be included in the user device 140.

The historical data, market benchmark data, and/or data related to the proposed deal may be displayed on a display device, such as display device 108. Workstation 102 includes the display device 108 for viewing the historical data, the market benchmark data, and/or the data related to the proposed deal to enable the user to, for example, determine an optimized pricing model to reduce delays in providing optimized bids and/or increase effectiveness of the optimized bids for market participation. In a further embodiment, display device 108 may be configured to display, to a user, exchangeable pairs of services and/or an optimized service package model, as will be described in further detail below. Display device 108 may also permit a user to interact with the workstation 102 and its components and functions, or any other element within the system 100. This may be further facilitated by an interface 110, which may include a keyboard, mouse, a joystick, a haptic device, or any other peripheral or control to permit user feedback from and interaction with the workstation 102.

A service generator 120 is stored in memory 106 and is configured to formulate a service package having a plurality of service items to be provided over a network. The service package may be generated based on objectives of the proposed deal 148. In an embodiment, the service generator 120 may determine a target value for the proposed deal 148. In some embodiments, the service generator 120 determines the target value based on the objectives of the historical deals (e.g., stored in historical database 144) and the proposed deal 148. In an embodiment, the service generator 120 may calculate cost values for each historical deal using a plurality of pricing methods, such as a historical pricing method. The service generator 120 may select one or more first pricing methods when the one or more first pricing methods generates a calculated cost close to an actual price. The actual price is the price that the historical bid was accepted at. Consequently, the service generator 120 may select one or more first pricing methods that most accurately reflects the cost for the historical deal. In further embodiments, the service generator 120 may apply a weighted value on the selected first pricing method(s) based on objectives of the historical deal, as will be described in further detail below. Accordingly, a relationship between the selected first pricing method(s) and the objectives of the historical deal(s) may be established and may be employed in selecting one or more pricing methods for the proposed deal 148.

In yet a further embodiment, the service generator 120 may calculate costs for a proposed deal, such as proposed deal 148, using a plurality of pricing methods. The pricing methods for the proposed deal 148 may be the same as the pricing methods employed to calculate the costs for the historical deal(s). The service generator 120 may, in some embodiments, select one or more second pricing methods for the proposed deal 148 based on the objectives of the proposed deal 148 and the weighted value.

In an embodiment, the service generator 120 may compare the selected method(s) for the historical deal(s) and the selected method(s) for the proposed deal to determine the target value (e.g., target cost) and/or difference value between the target value and a historical value (e.g., historical cost). For example, the service generator 120 may compare the calculated costs for the one or more first pricing methods and the calculated costs for the one or more second pricing methods to determine the target cost.

In some embodiments, the target value may be a cost value that is less than the historical cost and/or close to the market benchmark data (e.g., a market benchmark cost). The historical cost is the cost that is produced by using unit costs of historical deals and the information of the proposed deal 148. More specifically, the historical cost is calculated by multiplication of unit costs of the services and baselines for each service if included services are all quantitative services with baselines. Market benchmark data may include costs established by reports published by benchmark companies, such as retrieving unit costs for each service from the reports, and multiplying the unit costs and baselines of the proposed deal 148. Further details regarding the service generator 120 will be described in further detail below.

With continued reference to FIG. 1, memory 106 may include an anomaly indexer 122 which may be configured to determine and/or calculate an anomaly index for each service of the proposed deal 148 and/or service package based on service-level unit costs for each service of historical deals. The anomaly indexer 122 may also determine an anomaly threshold value. In an embodiment, the anomaly threshold value may include a predetermined threshold level of anomalous costs to adjust services included in the proposed deal 148 and/or generated service package. The predetermined threshold level of anomalous costs may include service-level unit costs for services that deviate from standard services/service costs.

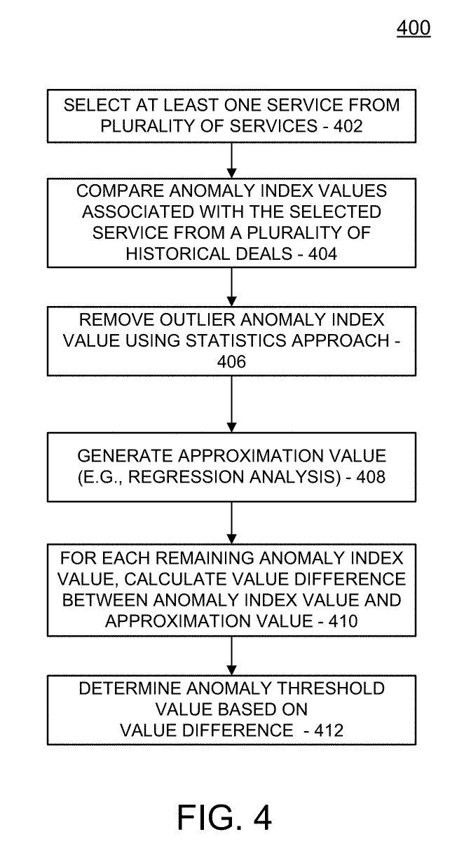

For example, the anomaly threshold value may include a maximum value when custom services are to be included in the proposed deal 148 (e.g., when the proposed deal 148 is adjusted to include custom services). In addition, the anomaly threshold value may include a minimum value when adjustments to the proposed deal 148 should be minimal (e.g., when the proposed deal 148 should include standard services and/or is minimally adjusted). In some embodiments, the anomaly threshold value may be expressed as a percentage value. Further details of the anomaly indexer 122 will be described in further detail with reference to FIG. 4.

The service reassignment unit 124 may be configured to automatically identify exchangeable services corresponding to services in the proposed deal 148 and exchange/replace such services in the proposed deal 148 based on the anomaly index to provide an optimized service package model. In some embodiments, exchangeable services may be replaced and/or adjusted in the proposed deal 148 when a total cost for the proposed deal 148 exceeds the target value, as determined by the service generator 120. The total cost of the proposed deal 148 may be calculated by, for example, multiplication of unit costs and baselines for each service if included services are all quantitative services with baselines. The total cost of the proposed deal 148 may include a summation of all service-level unit costs for each service in the proposed deal 148. In some embodiments, the service reassignment unit 124 may automatically adjust the services in the proposed deal 148 to provide an optimized service package model having a total cost less than the original cost of the proposed deal 148 and/or original service package. The optimized service package model may include a portion of the services of the original proposed deal 148 and one or more substitute services to generate an optimized service package and/or an optimized bid.

For example, when the total cost of the proposed deal 148 exceeds the target cost, the service reassignment unit 124 may identify at least one excludable service in the proposed deal 148 to be excluded. In some embodiments, the least one excludable service may exceed the anomaly index. The service reassignment unit 124 may further identify at least one substitute service (e.g., an includable service) in the proposed deal 148 to be included in an optimized service package. In some embodiments, the least one substitute service may have an anomaly index value below the anomaly threshold value such that substitute service does not exceed the anomaly threshold value. Accordingly, the service reassignment unit 124 may efficiently adjust the proposed deal 148 to provide an optimized service package model such that the optimized service package model includes some of the original services of the proposed deal 148 and one or more substitute services. Further details of the service reassignment unit 124 will be described in further detail below.

With continued reference to FIG. 1, an updater 126 may replace the original service package with the optimized service package. In some embodiments, the updater 126 may replace the service package with the optimized service package over a network, such as a computer network and/or communications network. The updater 126 may provide the optimized service package to one or more storage devices, such as memory 106. For example, the updater 126 may provide the optimized service package to one or more client devices. In some embodiments, a service provider 128 may provide service items in the optimized service package remotely on the network.

A bid generator 130 may be configured to submit the optimized service package model during the bidding process and/or to determine a total cost of the optimized service package model. The total cost of the optimized service package model may include a summation of all service items and/or service-level unit costs for each service item included in the optimized service package model. In some embodiments, the bid generator 130 may submit the optimized service package model as a bid to one or more clients during the bidding process when the total cost of the optimized service package model 126 is below the target cost.

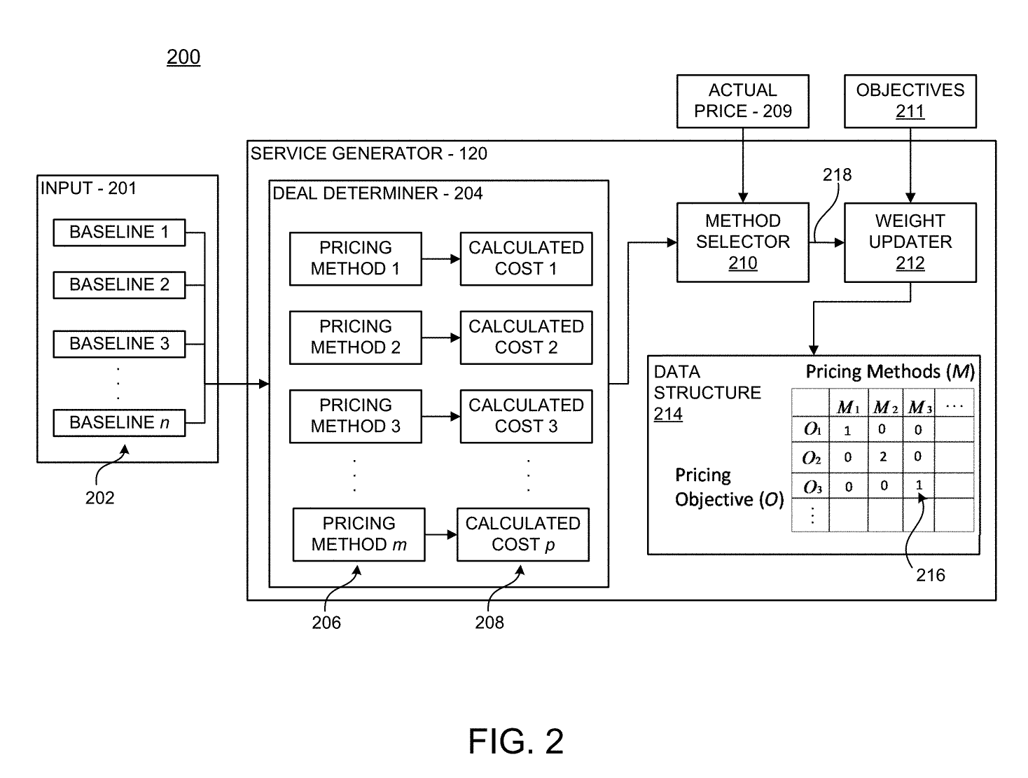

Now referring to FIG. 2, a block/flow diagram of a system/method 200 for the service generator 120 for determining the target cost using objectives of historical deals is illustratively depicted, in accordance with an embodiment of the present principles. In an embodiment, the service generator 120 may receive input data 201 including baselines 1, . . . , n 202 of one or more historical deals. The baselines may be employed to calculate costs for each service by multiplying baselines and unit costs. For each historical deal, a deal determiner 204 may determine a calculated cost 1, . . . , p 208 corresponding to each pricing method 1, . . . , m 206. For example, a plurality of pricing methods 206 may employed to determine a corresponding cost 208 associated with each of the pricing methods 206, and each pricing method 206 may include a plurality of service-level unit costs. Pricing methods may include, but are not limited to, pricing methods based on historical data, such as historical data provided by historical database 144, and/or by referencing market benchmark, such as market benchmark data provided by market benchmark database 146, top-down approaches, bottom-up approaches, etc.

A method selector 210 may select one or more first pricing methods 218 (e.g., a first selected pricing method) when the calculated costs 208 associated with the pricing methods 206 are similar to an actual price 209. The actual price 209 is the price at which the historical deal(s) was accepted and may be provided as user input to the target cost generator 120. It is readily contemplated that that the first selected pricing method 218 may include more than one pricing method.

In a further embodiment, a weight updater 212 may apply a weight value 216 to the first selected pricing methods 218 if such methods achieve one or more objectives 211 of the historical deals. For example, the objectives 211 of the historical deals may include pricing objectives, such as a total budget scheme. When the first selected pricing methods 218 achieve that particular objective, the weight updater 212 applies a weight value 216 (e.g., +1) to each of the first selected pricing methods 218 to provide a data structure 214 indicating a link between the objectives of the historical deals 211 and the first selected pricing methods 218. For example, as illustrated in FIG. 2, pricing methods M₁, M₂ and M₃ have been selected as first selected pricing methods 218. When objectives O₁, O₂ and O₃ of a historical deal are input into the weight updater 212, the weight updater 212 adds a weight value 216 to each of the first selected pricing methods 218 that achieve the objective 211. In further embodiments, the data structure 214 may be employed to determine pricing methods for a proposed deal.

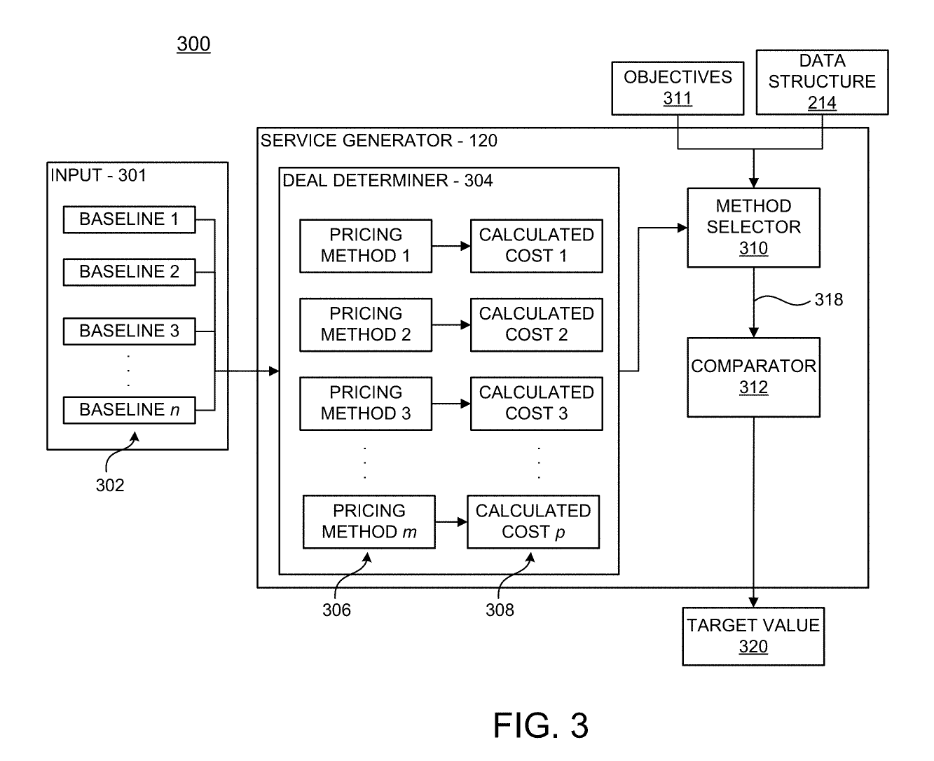

Now referring to FIG. 3, a block/flow diagram of a system/method 300 for the service generator 120 for formulating a service package and/or determining the target cost using objectives of historical deals is illustratively depicted, in accordance with an embodiment of the present principles. It should be noted that the deal determiner 304 and/or method selector 310 may be the same as deal determiner 204 and/or method selector 210 of FIG. 2. In an embodiment, the service generator 120 may receive input data 301 including baselines 1, . . . , n 302 of the proposed deal, such as proposed deal 148 of FIG. 1.

In an embodiment, the deal determiner 304 may formulate a service package including service items (e.g., original services) to be included and/or calculate costs 308 for the proposed deal 148 using a plurality of pricing methods 306. For example, the deal determiner 304 may employ one or more pricing methods 306, each of which include one or more service-level unit costs, to determine a calculated cost 308 associated with the pricing method 306. The pricing methods 306 may be the same and/or similar to the pricing methods 206 employed to calculate the costs for the historical deal(s), as depicted in FIG. 2.

The following example is described for illustrative purposes. For example, a user may input 301 baselines 302 for the proposed deal 148 in the target cost generator 120. In some embodiments, a user may input 301 a baseline 302 for each service for the proposed deal 148, such as 100,000 servers for Intel server service and/or 500 Terabytes (TB) for database server service, via interface 110 of FIG. 1. It should be understood that a list of services, such as a service menu, may be predefined by an outsourcing service provider. The list of services may include, but is not limited to, Intel server service, database server service, disaster recovery service, etc. Accordingly, the deal determiner 304 may determine which services (e.g., original services) are to be included in the proposed deal 148 and a calculated cost associated with the proposed deal.

Suppose, for example, there is only one service to be included in the proposed deal 148. Pricing method 1, for example, may include a method using a unit cost determined from historical deals (e.g., $1000 USD per server). In addition, pricing method 2, for example, may include a method using a unit cost derived from market benchmark data (e.g., $800 USD per server). When the proposed deal 148 includes a baseline of, for example, 100,000 servers for Intel server service, the deal determiner 304 may calculated costs as follows:

Calculated Cost 1=$1000*100,000 (baseline)=$100,000,000 USD

Calculated Cost 2=$800*100,000 (baseline)=$80,000,000 USD

A method selector 310 may select one or more second pricing methods 318 for the proposed deal (e.g., a second selected pricing method) based on objectives of the proposed deal 311 and/or the data structure 214 provided in FIG. 2. In some embodiments, the method selector 310 selects the second selected pricing method(s) 318 with priority based on the objectives of the proposed deal 311. For example, from the objectives 311 and data structure 214, the method selector 310 identifies second pricing methods which are suitable for the proposed deal 148. Since the data structure 214 has a weighed value for each pricing method, the method selector 310 may weigh the pricing methods. For example, suppose a proposed deal 148 is related to three objectives O₁, O₂ and O₃. From data structure 214, it is known that the weighed values for O₁, O₂, and O₃ are 1, 2 and 1, respectively, for pricing methods M₁, M₂ and M₃, respectively, as shown in FIG. 2. Assuming, for example, the calculated costs 1, 2 and 3 of 308 are 100, 110 and 120, respectively, the target cost may be 100*0.25+110*0.5+120*0.25=110.

A further example is described for illustrative purposes. Suppose the calculated costs 308 for the proposed deal 148 based on historical deals (e.g., pricing method 1) is $100 million USD. In addition, suppose the calculated costs 308 for the proposed deal 148 based on market benchmark data (e.g., pricing method 2) is $50 million USD. The proposed deal 148 may include an objective 311 such as, for example, to compete with competitors with a cost close to market benchmark. In some embodiments, the method selector 310 may select one or more second pricing methods for the proposed deal 148 that achieve the proposed deal's objectives 311. For example, the method selector 310 may apply a weight value, such as 80% to the market benchmark cost and apply a weight value of 20% to the historical deal cost. Accordingly, the target cost may be a function of $100 million USD (calculated costs based on historical deals) multiplied by 80% and/or $50 million USD (calculated costs based on market benchmark) multiplied by 20%.

In a further embodiment, a comparator 312 may compare the first selected pricing method(s) 218 and the second selected pricing method(s) 318 to determine a target cost 320. For example, the comparator 312 may compare price points of the selected methods and determine an average between the calculated costs 206 associated with the first selected pricing method(s) 218 and the calculated costs 306 associated with the second selected pricing method(s) 318. In an embodiment, the target cost 320 may be a function of both the historical deals and/or the proposed deal. In some embodiments, the target cost 320 is lower than the historical cost. In further embodiments, the target cost 320 may include a difference value D, wherein the difference value D is a value of the difference between the historical cost and the target cost 320.

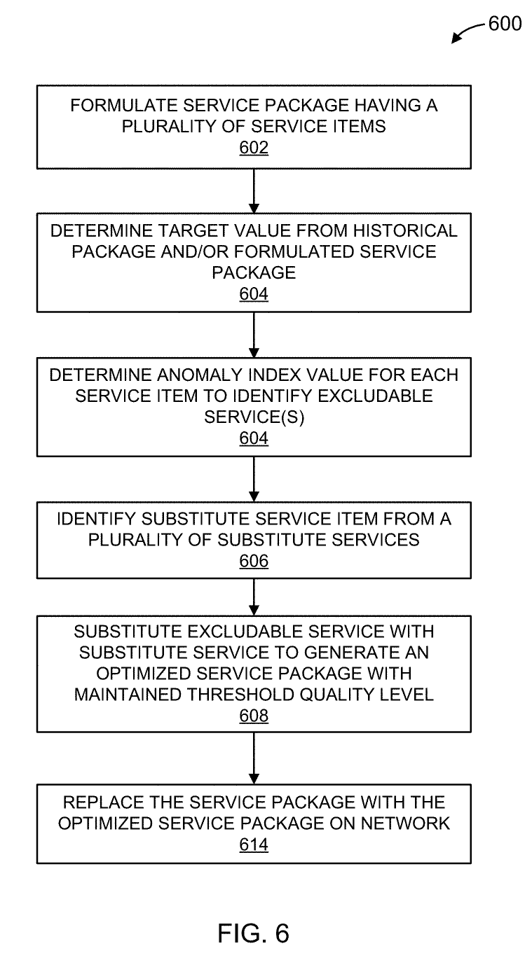

It is to be appreciated that any of system 200 of FIG. 2 and/or system 300 in FIG. 3 may be implemented in one or more of the elements of system 100 of FIG. 1. Further, it is to be appreciated that processing system 100 of FIG. 1, system 200 of FIG. 2, and/or system 300 in FIG. 3 may perform at least part of the method described herein including, for example, at least part of method 400 of FIG. 4 and/or method 600 of FIG. 6.

Now referring to FIG. 4, a block/flow diagram of a system/method 400 for determining an anomaly index and/or anomaly threshold value for the proposed deal 148 based on service-level unit costs for each service of historical service packages is illustratively depicted, in accordance with an embodiment of the present principles. It is readily contemplated that the anomaly indexer, such as the anomaly indexer 122 of FIG. 1, is configured to perform the method 400. As shown in block 402, at least one service from a plurality of services may be selected. In block 404, anomaly index values associated with the selected service may be compared across a plurality of historical deals. For example, the anomaly index values may be determined based on unit costs and/or baselines of the at least one service. Each of the unit costs and/or baselines for the at least one service may be represented as a data point on a graph to provide a plurality of data points. In some embodiments, the unit costs and/or baselines of the at least one service may be derived from one or more historical deals.

In block 406, at least one outlier anomaly index value (e.g., outlier data point) may be removed and/or excluded using a statistics approach. A statistics approach may include, but is not limited to, a Smirnov-Grubbs, normal distribution approach, etc. In some embodiments, the at least one data point (e.g., an outlier data point) may be excluded when the at least one data point deviates from the normal distribution of the plurality of data points.

In block 408, an approximation value of the remaining anomaly index values may be generated using a regression analysis approach. It is readily contemplated that the regression analysis approach may include, but is not limited to, linear, logarithmic, and/or any similar statistical method. For each remaining data point, a difference value between each anomaly index value and the approximation value may be calculated, as illustrated in block 410. For example, a difference value between each anomaly index value and the logarithmic approximation value may be calculated when a logarithmic approximation approach is employed.

In block 412, an anomaly threshold value a may be calculated. In some embodiments, the anomaly threshold value a may be defined by the following formula:

$$a = \frac{100 * d}{max ( d )}$$

where a is the anomaly threshold value and d is the difference value between each anomaly index value (e.g., data point) and the approximation value. The anomaly threshold value a may be a value between 0 and 100 (e.g., 0≦a≦100). In some embodiments, a predetermined threshold level may be selected for the anomaly threshold value. The anomaly index may, in some embodiments, be employed to exclude original services of a proposed deal and/or include substitute services to adjust a proposed deal such that the target cost is not exceeded, as will be described in further detail below.

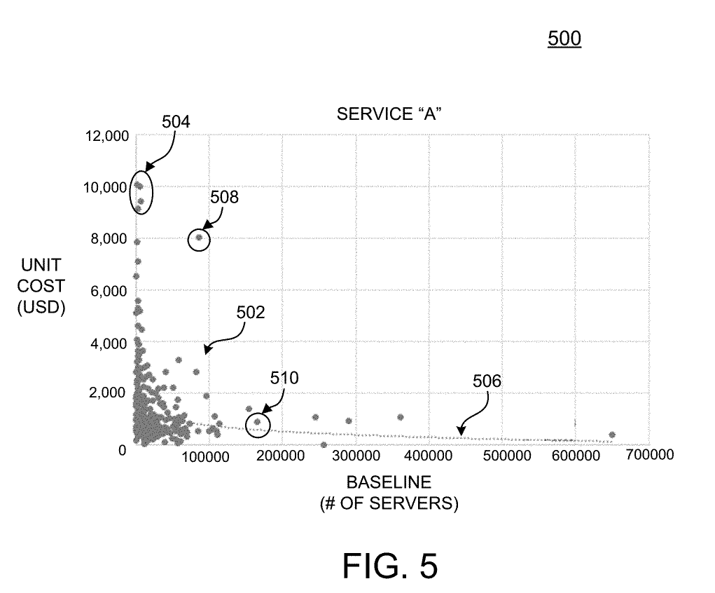

Referring to FIG. 5, with continued reference to FIG. 4, an exemplary unit cost/baseline graph 500 for Service “A” is illustratively depicted, in accordance with an embodiment of the present principles. Service “A” may include any particular service(s) that may be provided by a service provider. The graph 500 may include a plurality of anomaly index values (e.g., data points) 502 representative of Service “A” included in a plurality of historical deals. As illustrated in FIG. 5, the graph 500 may include unit costs (y-axis) and baselines (x-axis) for each of the data points 502. While units of measurement, such as U.S. Dollars (USD) and number of servers, are shown, it is readily contemplated that other units of measurement may be employed.

The outlier anomaly index values (e.g., outlier data points) 504 represent an example of data points that may be excluded and/or removed after a statistics approach is employed, as described above with reference to block 406 of FIG. 4. An approximation value, such as logarithmic approximation 506, may be determined using regression analysis. In further embodiments, a value difference between each of the remaining data points, such as 508 and 510, and the logarithmic approximation 506 may be calculated to determine an anomaly index. For example, the value difference (e.g., unit cost) between data point 508 (e.g., an excludable data point) and the logarithmic approximation 506 may be higher than the value difference between data point 510 (e.g., an includable data point) and the logarithmic approximation 506. Accordingly, the data point 508 may have a higher anomaly index compared to the data point 510, since data point 510 is closer to the logarithmic approximation 506. In some embodiments, the anomaly index may be employed to exclude data point 508 and replace data point 508 with data point 510 for a proposed deal to provide an optimized pricing model, as will be described in further detail below.

Referring now to FIG. 6, a block/flow diagram of a system/method 600 for determining an optimized service package model having a plurality of service-level unit costs is illustratively depicted, in accordance with an embodiment of the present principles. In block 602, the method 600 may include formulating at least one service package (e.g., proposed deal), the at least one service package including a list of a plurality of services. The plurality of services may include computer-related services provided over a network.

In block 604, the method 600 may include determining a target value from at least one historical deal and the at least one proposed deal. In some embodiments, the target value may be determined by comparing first selected pricing methods based on one or more historical deals and second selected pricing methods based on a proposed deal. In further embodiments, the first selected pricing methods and/or the second selected pricing methods may be selected based on the objectives of the one or more historical deals and the proposed deal, respectively.

In block 606, the method 600 may include determining an anomaly index for each service item of the formulated service package to identify at least one service item in the service package to be excluded. For example, the service item to be excluded may include an anomaly index value that exceeds the anomaly threshold value. The anomaly index value for the service package may be based on service-level unit costs for each service of historical deals. It should be understood that block 606 of FIG. 6 may include, for example, any of method 400 of FIG. 4.

With continued reference to FIG. 6, the method 600 may include identifying a substitute service (e.g., exchangeable pair) for the at least one service in the original service package to be excluded. In some embodiments the substitute service item may be identified based on baseline similarities between the services. In an embodiment, the method 600 may include substituting at least one service item to be excluded with the substitute service to generate an optimized service package, as illustrated in block 610. In some embodiments, the optimized service package has a maintained threshold quality level similar to the original service package. For example, the amount of service items may be maintained such that a quality of the service package is not altered once a service item is replaced. In block 610, the method 600 may include substituting the excludable service with a substitute service to reduce the total cost of the proposed deal.

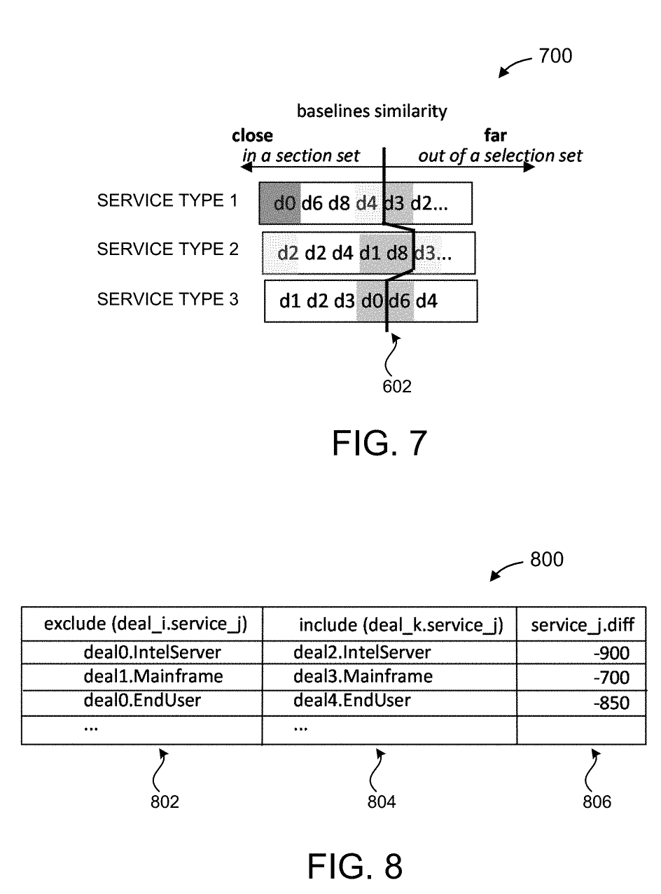

For example, the proposed deal may include a plurality of services, each service having a service-level unit cost. The summation of the service-level unit costs for all the services provided in the proposed deal is the total cost of the proposed deal. When the total cost of the proposed deal exceeds the target cost, at least one service in the proposed deal (e.g., an excludable service) may be replaced with a service having a lower service-level unit cost (e.g., an includable/substitute service). It is readily contemplated that modifying the at least one service, as illustrated in block 606, may include any features of FIG. 7 and/or FIG. 8, which will be described in further detail below.

In some embodiments, an excludable service may include an anomaly index higher than the substitute service. Accordingly, the optimized service package model may include an optimized service package having a list of services, such that the services include some of the original services of the proposed deal (e.g., original service package) and one or more substitute services. In a further embodiment, the method 600 may include replacing the original service page with the optimized service package on the network, as depicted in block 612. In a further embodiment, at least one bid associated with the optimized service package may be generated.

Referring to FIG. 7, with continued reference to FIG. 1, an exemplary baseline similarity illustration 700 is shown, in accordance with an embodiment. It is should be understood that the service reassignment unit 124 of FIG. 1 may perform the functions described below with reference to FIG. 7. In an embodiment, the service reassignment unit 124 may identify exchangeable pairs of services for at least one service included in a proposed deal when the total cost of the proposed deal exceeds the target cost. Exchangeable pairs of services may include services that include a similar function with varying service-level unit costs.

In some embodiments, the service reassignment unit 124 may sort service types and/or service-level unit costs for services included in the proposed deal. For example, as illustrated in FIG. 7, three service types are shown for exemplary purposes, namely Service Type 1, Service Type 2, and Service Type 3. Each of these service types include similar services, such as the least one service included in the proposed deal. When the target cost is exceeded, the service reassignment unit 124 may identify similar services for the at least one service to determine at least one excludable service. Specifically, the service reassignment unit 124 may identify Service Type 1 which may include similar services d0, d6, d8, etc. In some embodiments, similar services may be identified by comparing the baseline similarity between the services. Baseline similarity may be derived from a distance of Euclidian distance between two baselines.

In an embodiment, the service reassignment unit 124 may sort service-level unit costs for all service types based on how much the unit cost contributes to the total cost. For example, assume that there are two service types, such as Service Type 1 and Service Type 2, with the same unit costs with only one selected service-level unit cost. In addition, assume that a baseline of Service Type 1 for the proposed deal is 1000 while a baseline for Service Type 2 is 10. Accordingly, altering the unit cost of Service Type 1 is effective to altering the total cost. In this case, the unit cost of Service Type 1 is prioritized to be excluded compared to the unit cost of Service Type 2. In some embodiments, the sorting may include prioritizing the unit cost of Service Type 1 followed by the unit cost of Service Type 2.

In a further embodiment, the service reassignment unit 124 may filter the sorted unit costs when a unit cost for a particular service is close to and/or exceeds the anomaly index. For example, the service reassignment unit 124 may identify an exchangeable pair of services for service d0, service d0 being at least one service in the proposed deal. Service d0 may include a unit cost that exceeds the anomaly index 602. Accordingly, the service reassignment unit 124 may modify at least one service in the proposed deal (e.g., service d0) by excluding service d0 (e.g., an excludable service) and replacing service d0 with a substitute service d2, service d2 having a unit cost that is closer to the anomaly index 602 and/or does not exceed the anomaly index 602. In some embodiments, the exchangeable pairs of services, including sorted and/or filter exchangeable services, may be displayed to the solution designer on the display 108 of FIG. 1. Accordingly a smaller set of exchangeable pairs may be displayed to the solution designer to increase efficiency in modifying the proposed deal. In addition, the quality of the proposed deal remains relatively unaffected even after modification since the number of services included in the modified proposed deal remains the same.

In further embodiments, the service reassignment unit 124 may filter potential substitute services when the similar services for the exchangeable pairs substantially exceed the anomaly index 602, thereby reducing the amount of substitute services for the solution designer to review. For example, with reference to FIG. 7, if service d0 for Service Type 3 is an excludable service and service d6 is a potential substitute service, service d6 may be automatically removed if service d6 exceeds the anomaly index 602.

To create a sorted service-level unit cost for each historical deal shown in FIG. 7, baselines for a proposed deal may be used. How far the historical deal is measured by calculating a Euclid distance between a baseline of a proposed deal and a baseline of the historical deal. If the distance is zero, the baseline of the historical deal is the same as the baseline of the proposed deal. Therefore, the historical deal is decided as “close” in a selection set to the proposed deal and/or “far” out of a selection set. Accordingly, it may be advantageous to select unit costs from historical deals with similar baselines.

Now referring to FIG. 8, with continued reference to FIG. 7, an exemplary table 800 illustrating excludable services 802, substitute services 804, and a service-level unit cost difference 806 between excludable services 802 and substitute services 804 is shown. In accordance with the present principles, the at least one service in the proposed deal may include an excludable service 802. The excludable service may be replaced by a substitute service, thereby modifying the proposed deal and generating an optimized pricing model. The service-level unit cost difference 806 between excludable services 802 and substitute services 804 illustrates a reduction in service-level unit cost by replacing the excludable service with the substitute service 804, thereby reducing the total cost of the proposed deal.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

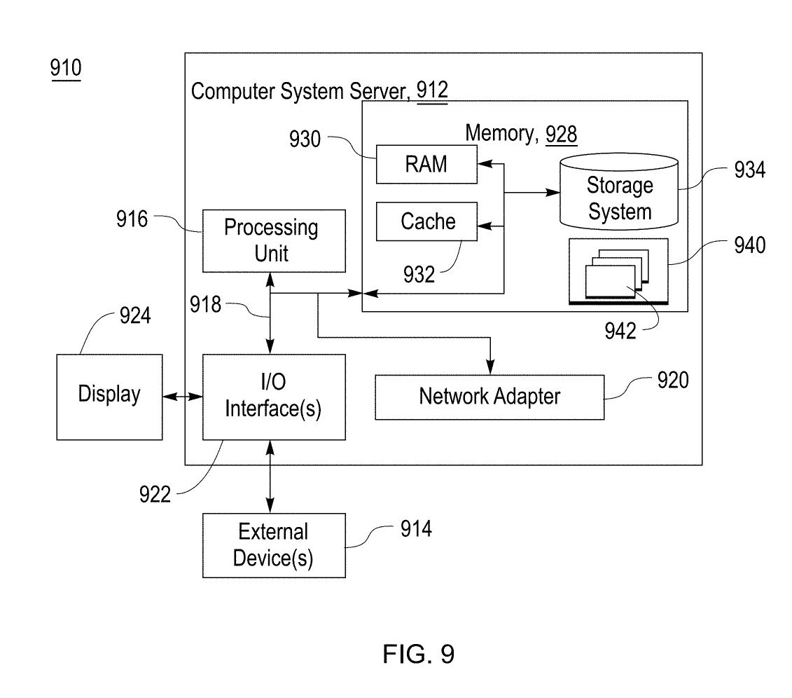

Referring now to FIG. 9, a schematic of an example of a cloud computing node 910 is shown. Cloud computing node 910 is only one example of a suitable cloud computing node and is not intended to suggest any limitation as to the scope of use or functionality of embodiments of the invention described herein. Regardless, cloud computing node 910 is capable of being implemented and/or performing any of the functionality set forth hereinabove.

In cloud computing node 910 there is a computer system/server 912, which is operational with numerous other general purpose or special purpose computing system environments or configurations. Examples of well-known computing systems, environments, and/or configurations that may be suitable for use with computer system/server 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system executable instructions, such as program modules, being executed by a computer system. Generally, program modules may include routines, programs, objects, components, logic, data structures, and so on that perform particular tasks or implement particular abstract data types. Computer system/server 912 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 912 in cloud computing node 910 is shown in the form of a general-purpose computing device. The components of computer system/server 912 may include, but are not limited to, one or more processors or processing units 916, a system memory 928, and a bus 918 that couples various system components including system memory 928 to processor 916.

Bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 912 typically includes a variety of computer system readable media. Such media may be any available media that is accessible by computer system/server 912, and it includes both volatile and non-volatile media, removable and non-removable media.

System memory 928 can include computer system readable media in the form of volatile memory, such as random access memory (RAM) 930 and/or cache memory 932. Computer system/server 912 may further include other removable/non-removable, volatile/non-volatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 918 by one or more data media interfaces. As will be further depicted and described below, memory 928 may include at least one program product having a set (e.g., at least one) of program modules that are configured to carry out the functions of embodiments of the invention.

Program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein.

Computer system/server 912 may also communicate with one or more external devices 914 such as a keyboard, a pointing device, a display 924, etc.; one or more devices that enable a user to interact with computer system/server 912; and/or any devices (e.g., network card, modem, etc.) that enable computer system/server 912 to communicate with one or more other computing devices. Such communication can occur via Input/Output (I/O) interfaces 922. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, redundant processing units, external disk drive arrays, RAID systems, tape drives, and data archival storage systems, etc.

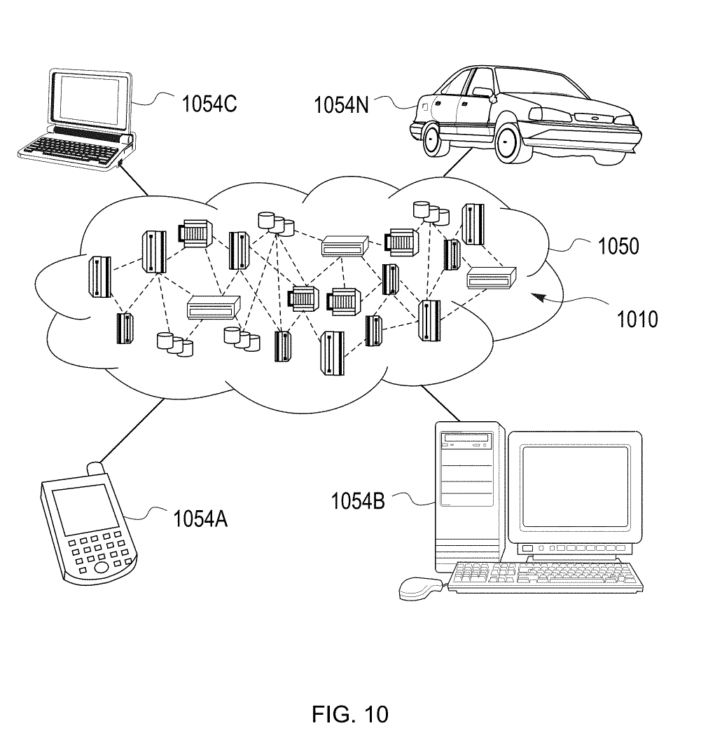

Referring now to FIG. 10, illustrative cloud computing environment 1050 is depicted. As shown, cloud computing environment 1050 includes one or more cloud computing nodes 1010 with which local computing devices used by cloud consumers, such as, for example, personal digital assistant (PDA) or cellular telephone 1054A, desktop computer 1054B, laptop computer 1054C, and/or automobile computer system 1054N may communicate. Nodes 1010 may communicate with one another. They may be grouped (not shown) physically or virtually, in one or more networks, such as Private, Community, Public, or Hybrid clouds as described hereinabove, or a combination thereof. This allows cloud computing environment 1050 to offer infrastructure, platforms and/or software as services for which a cloud consumer does not need to maintain resources on a local computing device. It is understood that the types of computing devices 1054A-N shown in FIG. 10 are intended to be illustrative only and that computing nodes 1010 and cloud computing environment 1050 can communicate with any type of computerized device over any type of network and/or network addressable connection (e.g., using a web browser).

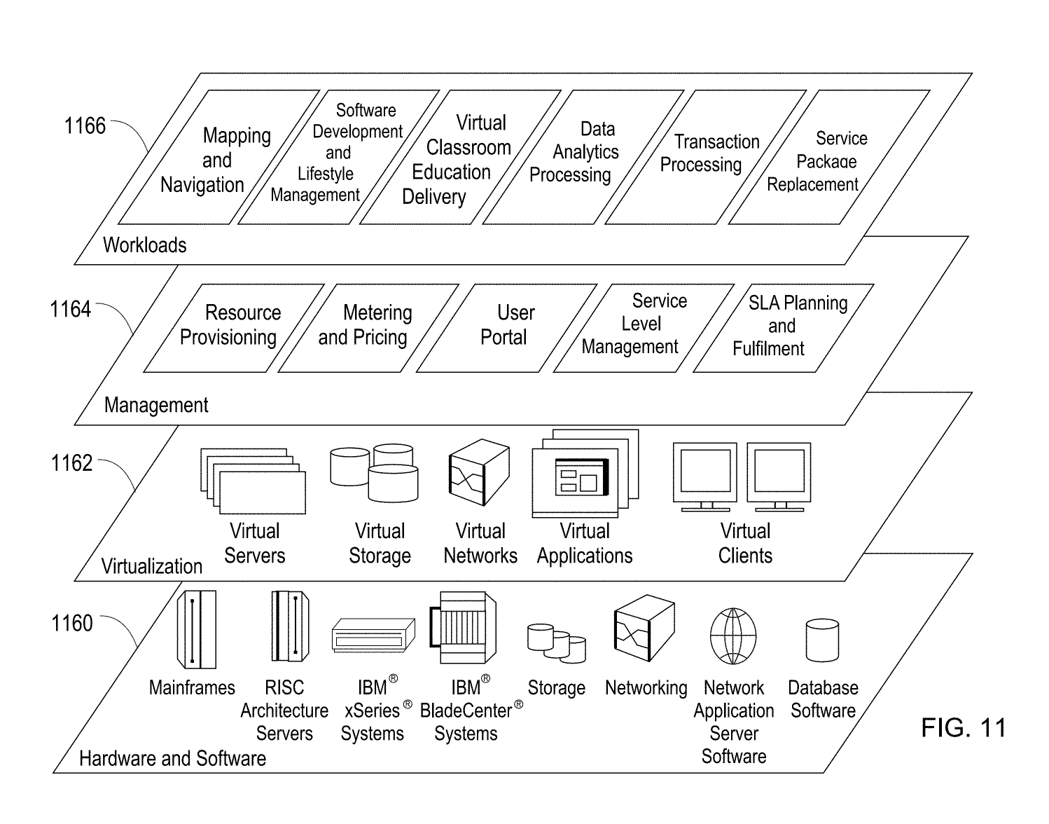

Referring now to FIG. 11, a set of functional abstraction layers provided by cloud computing environment 1050 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 1160 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1162 provides an abstraction layer from which the following examples of virtual entities may be provided: virtual servers; virtual storage; virtual networks, including virtual private networks; virtual applications and operating systems; and virtual clients.

In one example, management layer 1164 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1166 provides examples of functionality for which the cloud computing environment may be utilized. Examples of workloads and functions which may be provided from this layer include: mapping and navigation; software development and lifecycle management; virtual classroom education delivery; data analytics processing; transaction processing; and service package replacement.

Having described preferred embodiments for determining an optimized service package model for market participation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for adjusting service items in service packages, the method comprising:
formulating a service package having a plurality of service items, at least one of the plurality of service items including a computer-related service provided over a network;
determining an anomaly index value for each service item to identify at least one service item in the service package to be excluded, wherein the anomaly index value for the at least one service item to be excluded exceeds an anomaly threshold value;
identifying at least one substitute service item from a plurality of substitute services to replace the at least one service item to be excluded;
substituting the at least one service item with the at least one substitute service item to generate an optimized service package having a maintained threshold quality level, wherein the optimized service package includes a portion of the plurality of service items and one or more substitute service items; and
replacing the service package with the optimized service package on the network.

2. The method of claim 1, wherein determining the anomaly threshold value comprises:
comparing a plurality of anomaly index values associated with at least one historical service item selected from a plurality of historical packages;
generating an approximation value based on the plurality of anomaly index values; and
calculating a value difference between the plurality of anomaly index values and the approximation value, wherein the anomaly threshold value is based on the value difference.

3. The method of claim 2, further comprising removing at least one outlier anomaly index value from the plurality of anomaly index values using a statistics approach.

4. The method of claim 1, wherein the anomaly index value for the at least one substitute service item is below the anomaly threshold value.

5. The method of claim 1, wherein identifying the at least one substitute service item further comprises sorting each of the plurality of substitute services based on baseline values.

6. The method of claim 1, wherein identifying the at least one substitute service item further comprises excluding a substitute service item from the plurality of substitute service items when the anomaly index value for the substitute service item exceeds the anomaly threshold value.

7. The method of claim 1, wherein each service may include a plurality of subservices arranged in a hierarchical manner.

8. A processor-based device having at least a processor and a memory device for adjusting service items in service packages, comprising:
a service generator to formulate a service package having a plurality of service items, at least one of the plurality of service items including a computer-related service provided over a network;
an anomaly indexer to determine an anomaly index value for each service item to identify at least one service item in the service package to be excluded, wherein the anomaly index value for the at least one service item to be excluded exceeds an anomaly threshold value;
a service reassignment unit, coupled to the processor, to:
identify at least one substitute service item from a plurality of substitute services to replace the at least one service item to be excluded; and
substitute the at least one service item with the at least one substitute service item to generate an optimized service package having a maintained threshold quality level, wherein the optimized service package includes a portion of the plurality of service items and one or more substitute service items; and
an updater to replace the service package with the optimized service package on the network.

9. The device of claim 8, wherein the anomaly indexer is further configured to:
compare a plurality of anomaly index values associated with at least one historical service item selected from a plurality of historical packages;
generate an approximation value based on the plurality of anomaly index values; and
calculate a value difference between the plurality of anomaly index values and the approximation value, wherein the anomaly threshold value is based on the value difference.

10. The device of claim 9, wherein the anomaly indexer is further configured to remove at least one outlier anomaly index value from the plurality of anomaly index values using a statistics approach.

11. The device of claim 8, wherein the anomaly index value for the at least one substitute service item is below the anomaly threshold value.

12. The device of claim 8, wherein the service reassignment unit is further configured to sort each of the plurality of substitute services based on baseline values.

13. The device of claim 8, wherein the service reassignment unit is further configured to exclude a substitute service item from the plurality of substitute service items when the anomaly index value for the substitute service item exceeds the anomaly threshold value.

14. A non-transitory computer readable storage medium comprising a computer readable program for adjusting service items in service packages, wherein the computer readable program, when executed on a computer, causes the computer to perform the steps of:
formulating a service package having a plurality of service items, at least one of the plurality of service items including a computer-related service provided over a network;
determining an anomaly index value for each service item to identify at least one service item in the service package to be excluded, wherein the anomaly index value for the at least one service item to be excluded exceeds an anomaly threshold value;
identifying at least one substitute service item from a plurality of substitute services to replace the at least one service item to be excluded;
substituting the at least one service item with the at least one substitute service item to generate an optimized service package having a maintained threshold quality level, wherein the optimized service package includes a portion of the plurality of service items and one or more substitute service items; and
replacing the service package with the optimized service package on the network.

15. The non-transitory computer readable storage medium of claim 14, wherein determining the anomaly threshold value comprises:
comparing a plurality of anomaly index values associated with at least one historical service item selected from a plurality of historical packages;
generating an approximation value based on the plurality of anomaly index values; and
calculating a value difference between the plurality of anomaly index values and the approximation value, wherein the anomaly threshold value is based on the value difference.

16. The non-transitory computer readable storage medium of claim 15, further comprising removing at least one outlier anomaly index value from the plurality of anomaly index values using a statistics approach.

17. The non-transitory computer readable storage medium of claim 14, wherein the anomaly index value for the at least one substitute service item is below the anomaly threshold value.

18. The non-transitory computer readable storage medium of claim 14, wherein identifying the at least one substitute service item further comprises sorting each of the plurality of substitute services based on baseline values.

19. The non-transitory computer readable storage medium of claim 14, wherein identifying the at least one substitute service item further comprises excluding a substitute service item from the plurality of substitute service items when the anomaly index value for the substitute service item exceeds the anomaly threshold value.

20. The non-transitory computer readable storage medium of claim 14, wherein each service may include a plurality of subservices arranged in a hierarchical manner.
